(19) United States
(12) Patent Application Publication
(10) Pub. No.: US 2025/0268287 A1
(43) Pub. Date: Aug. 28, 2025

(54) CONTROL SYSTEM THAT AUTOMATICALLY ADJUSTS PROCESS VARIABLES IN OVEN BASED ON PRODUCT SURFACE TEMPERATURES

(71) Applicant: Quickfire Technologies, LLC, Hudson, WI (US)

(72) Inventor: Robert HANSON, Hudson, WI (US)

(21) Appl. No.: 18/924,916

(22) Filed: Oct. 23, 2024

Related U.S. Application Data
(60) Provisional application No. 63/545,228, filed on Oct. 23, 2023.

(51) Int. Cl. A23L 5/10; A23B 4/03; A23B 4/044

(52) U.S. Cl. CPC A23L 5/15; A23B 4/03; A23B 4/044; A23L 5/17

(57) ABSTRACT

Food processing and food science systems, apparatus and methods are disclosed. In particularly, an oven apparatus and cooking method are provided for processing meats and meat products, most particularly ham and roast beef. An oven control system is disclosed that controls the cooking process based on product surface temperature in addition to simply product core temperature. This control system allows the user to automatically optimize each process for food safety, drying rates, quality, cooking time, yield, and defect detection by programming the controller to adjust process conditions in food processing chambers such as steam cookers, water cookers, forced-air convection ovens, fermentation rooms, and drying rooms based on surface temperature measurements.

### 37 C.F.R. § 1.71 (e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### CROSS-REFERENCE TO RELATED APPLICATIONS, IF ANY

This application claims the benefit under 35 U.S.C. § 119 (e) of co-pending U.S. Provisional Patent Application Ser. No. 63/545,228, filed Oct. 23, 2024, which is hereby incorporated by reference.

If an Application Data Sheet(s) (ADS) has been filed in this application, it is incorporated by reference herein. Any applications claimed in an ADS for priority under 35 USC 119, 120, 121 or 365, and any and all parent, grandparent, great-grandparent, etc. applications of such applications, are also incorporated by reference, including any priority claims made in those applications and any material incorporated by reference, to the extent such subject matter is not inconsistent herewith.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

### 1. Field of the Invention

The present invention relates, generally, to food processing and food science systems, apparatus and methods. Particularly, the invention relates to oven apparatus and cooking methods. Most particularly, the invention relates to ovens and cooking methods for processing meats.

### 2. Background Information

When food products are cooked in free- or forced-convection ovens, the product internal core temperatures are commonly measured as an indicator of doneness. When the products are thought to be done, the oven door is opened and a manual temperature probe is inserted into the coldest part of the product to verify that the target core temperature has been achieved. Some ovens have an insertion probe connected to an external indicator or control system that externally displays the product temperature so that the product core temperature can be tracked for the entire process. Using a connected probe, the temperature probe is inserted into the product at the beginning of the cooking process so that the core temperature of the product can be monitored on an external display while the product is cooking. When the core temperature reaches a target temperature, the product is considered done and the cooking process is complete.

The product core is defined as the slowest cooking part of the product. Food products come in all different shapes and sizes, so the location of the core varies depending on the geometry of the product. If the product is a spherical shape such as meat balls, the core is at the geometric center. If the product is a long cylinder such as a ham log that is five foot long by 4.0 inch diameter, then the core is the entire center axis except near the ends where the temperature is affected by the end-heating effect.

The use of core temperature as an indication of doneness has been practiced for many years. Core temperature measurements are valuable for food safety to make sure that the coldest part of a product is cooked to a temperature adequate to destroy pathogenic food poisoning bacteria. Core temperatures are also useful for food quality, to make sure that products are cooked to a temperature that is adequate to achieve desired quality characteristics for texture or color. However, the core temperature measurement is not useful for monitoring changes to quality characteristics on the product surface, nor is it useful for monitoring or optimizing the effect of oven process conditions on moisture evaporation, moisture losses, surface dryness, surface hardness, or product yields. If the product surface temperatures were measured directly and recorded during cooking, this surface temperature data could be used to monitor and infer changes to surface dryness, drying rates, surface hardness, texture changes, and surface color changes as well as controlling the rates of protein denaturation and moisture loss. If the surface temperatures were compared with the wet-bulb temperature in the oven, this data could be used to indicate the degree of surface dehydration and thus the potential for desiccated bacteria that might survive the cooking process.

Existing technology in this field is believed to have significant limitations and shortcomings. For this and other reasons, a need exists for the present invention.

All US patents and patent applications, and all other published documents mentioned anywhere in this application are incorporated by reference in their entirety.

### BRIEF SUMMARY OF THE INVENTION

The invention provides an oven apparatus, method, method of manufacture and method of use which are practical, reliable, accurate and efficient, and which are believed to fulfill a need and to constitute an improvement over the background technology.

The invention provides an oven control system that controls the cooking process based on the product surface temperature (Ts) instead of just the internal or core temperature (Ti). This new control system allows the user to automatically optimize each process for food safety, drying rates, quality, cooking time, yield, and defect detection by programming the controller to adjust process conditions in food processing chambers such as steam cookers, water cookers, forced-air convection ovens, fermentation rooms, and drying rooms based on surface temperature measurements.

The Prior Art method of processing meat or meat products may be summarized in the following steps:
Step 1. heating meat at a predetermined ambient oven temperature (Ta);
Step 2. measuring an internal or core temperature (Ti) of the meat; and
Step 3. stop heating the meat when the internal temperature of the meat is equal to a predetermined safe internal temperature (Tis).

Between steps 1 and 2, the further Step or Steps of changing the first ambient temperature after a first period of time (Time-1) to a second (or further) ambient temperature(s) (Ta-x) for a second (or further) period(s) of time (T-x) may also be done.

In a basic aspect, the invention provides a method of processing meat or meat products, comprising steps of:
heating meat at a first ambient (or oven) temperature (Ta1);
measuring a surface temperature (Ts) of the meat;
changing the first ambient temperature to a second ambient temperature (Ta2) when the surface temperature reaches a predetermined target surface temperature (Ts1);
measuring an internal (core) temperature (Ti) of the meat; and
stop or cease heating the meat when the internal temperature of the meat is equal to a predetermined safe internal temperature (Tis).

In a more detailed aspect, the invention provides a method of processing meat or meat products that ensures not only safety, but improved color, texture, consistency, mouthfeel, flavor, aroma, and the like, comprising steps of;
Step 1) heating a meat article at a first ambient temperature (Ta1);
Step 2) measuring a surface temperature (Ts) of the meat article;
Step 3) changing the first ambient temperature to a second ambient temperature (Ta2) when the surface temperature of the meat article reaches a first predetermined target surface temperature (Ts1);
Step 4) changing the second ambient temperature to a third ambient temperature (Ta3) when the surface temperature of the meat article reaches a second predetermined surface temperature (Ts2)
Step 5) measuring an internal temperature (Ti) of the meat article; and
Step 6) stop heating the meat article when the internal temperature of the meat article is equal to a predetermined safe internal temperature (Tis).

In a yet more detailed aspect, the invention provides a method of processing meat that ensures not only safety, but optimum palatability including improved color, texture, consistency, mouthfeel, flavor, aroma, and the like, comprising steps of;
a) heating at least one meat article at a first ambient temperature (Ta1);
b) measuring a surface temperature (Ts) of the at least one meat article;
c) changing the first ambient temperature to a second ambient temperature (Ta2) when the surface temperature of the at least one meat article is equal a first predetermined target surface temperature (Ts1);
d) changing the second ambient temperature to a third ambient temperature (Ta3) when the surface temperature of the at least one meat article is equal to a second predetermined target surface temperature (Ts2);
e) changing the third ambient temperature to a fourth ambient temperature (Ta4) at a predetermined first period of time (T1);
f) measuring an internal temperature (Ti) of the at least one meat article;
g) continuing to heat the at least one meat article at the fourth ambient temperature when the internal temperature is equal to a predetermined safe internal temperature (Tis) for a predetermined second period of time (T2); and
h) stop heating the at least one meat article after the second predetermined period of time.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a graph of oven dry and wet bulb temperatures along with product core temperature, over time, for a typical, conventional smoked ham cooking process in the Prior Art.

FIG. 2 is a graph of oven dry- and wet-bulb temperatures along with the product core and surface temperatures, versus time, for a smoked ham cooking process in accordance with an embodiment of method and apparatus the present invention.

FIG. 3 is a graph of the oven steam temperature and the product core temperature, versus time, for a conventional roast beef cooking process in the Prior Art.

FIG. 4 is a graph of oven steam temperature and product core temperature along with product surface temperature, over time, for a roast beef cooking process in accordance with an embodiment of the method and apparatus of the present invention.

FIG. 5 is a graph of surface temperature over time of semi-dry meat snack stick showing surface temperature breaking above the wet-bulb temperature, utilizing an embodiment of the method and apparatus of the present invention. The inflection point where the surface temperature breaks above the wet-bulb temperature indicates the initiation of a common defect known as “case-hardening.”

FIG. 6 is a graph of the oven and surface temperatures versus time for barbecued beef brisket showing the surface temperature tracking with the wet-bulb temperature at 150° F. for over two hours, in accordance with the present invention, thus supplying a sufficiently lethal wetted-surface time-temperature heat treatment to destroy any pathogens that might exist on the surfaces under hydrated conditions. This graph also shows the inflection point where the surface temperature breaks above the wet-bulb temperature, indicating that the surface is dehydrated.

FIG. 7 is a flow diagram of a first basic embodiment of the method of the invention.

FIG. 8 is a flow diagram of a second embodiment of the method of the invention.

FIG. 9 is a flow diagram of a third embodiment of the method of the invention.

FIG. 10 is a diagram illustrating an embodiment of the apparatus of the invention.

### DETAILED DESCRIPTION

The description that follows describes, illustrates and exemplifies one or more embodiments of a food processing system and method. This description is not provided to limit the disclosure to the embodiments described herein, but rather to explain and teach various principles to enable one of ordinary skill in the art to understand these principles and, with that understanding, be able to apply them to practice not only the embodiments described herein, but also other embodiments that may come to mind in accordance with these principles. The scope of the instant disclosure is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers in cases where such labeling facilitates a more clear description. Additionally, the drawings set forth herein are not necessarily drawn to scale, and in some instances proportions may have been exaggerated to more clearly depict certain features.

The present invention concerns an oven control system that controls the cooking process based on the product surface temperature instead of just the core temperature. This new control system allows the user to automatically optimize each process for food safety, drying rates, quality, cooking time, yield, and defect detection by programming the controller to adjust process conditions in food processing chambers such as steam cookers, water cookers, forced-air convection ovens, fermentation rooms, and drying rooms based on surface temperature measurements.

### 1. The Value of Surface Temperature Measurement.

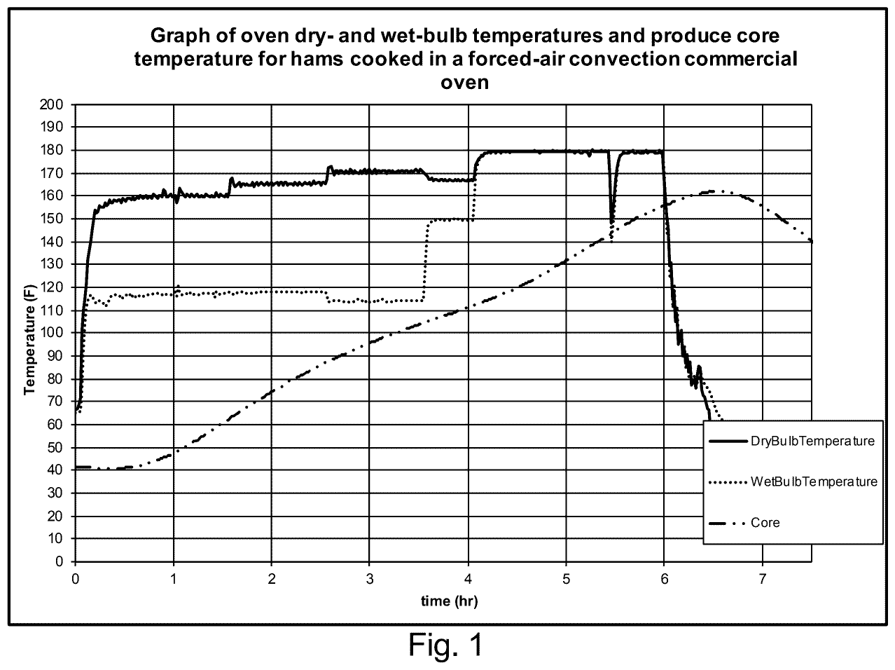

A typical graph of a conventional process for cooking netted hams in a commercial oven of the Prior Art is shown in FIG. 1. In this graph, the oven dry- and wet-bulb temperatures and the product core temperature, relative to time, are all shown, but not the surface temperature. This type of graph is commonly used in the industry, and graphs similar to this one would often be saved in manufacturer's food safety records for proof that the target core temperature was achieved for this load of product.

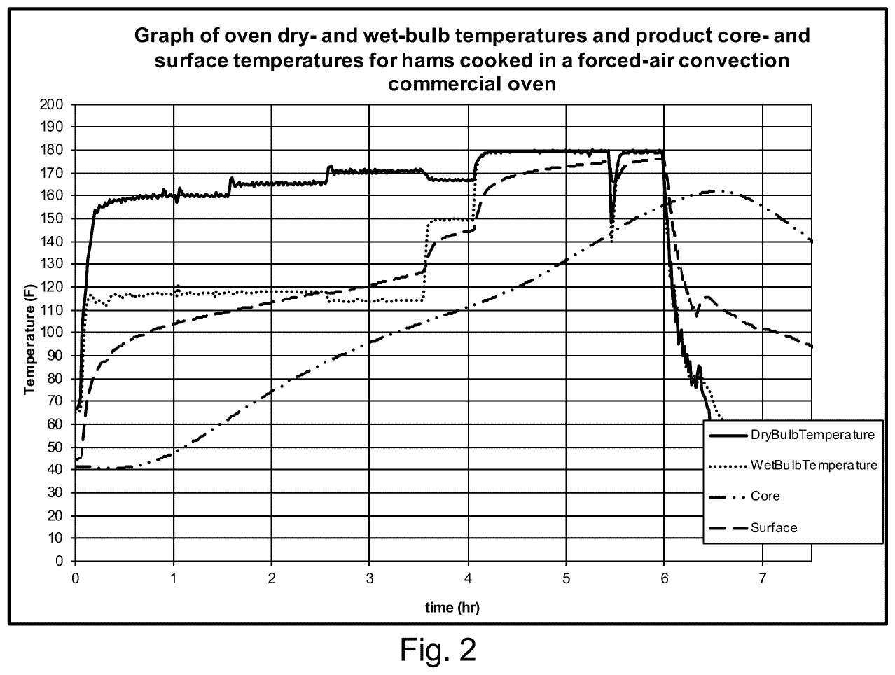

FIG. 2 is a graph illustrating a fundamental process of the present invention. On this graph the product surface temperature is also plotted. The surface temperature plot shows the effect of the oven temperatures and airflow on the surface temperature of the meat product, in this case, a load of smoked boneless hams. This graph is useful not only for establishing that the target core temperature was achieved, but also for determining the effect of the process conditions on the product surface temperature, as explained below.

For FIGS. 1 and 2, the oven wet-bulb temperature was measured using a conventional wet-bulb sensor where a moisture-wicking cotton sock was draped over an ordinary temperature sensor. Measurement of the wet-bulb temperature is a common practice used in many industrial ovens to measure and control relative humidity levels in the process air during cooking. Moisture evaporation from the wet-sock cools the sensor down to the wet-bulb temperature. As such, the wet-bulb temperature measures the temperature that moisture is evaporating in the oven during cooking. Meat products contain water, and during cooking, the water migrates to the surface and, as long as the surface is completely coated with moisture, the water evaporates from the surface at the wet-bulb temperature (FIG. 2). As the surface dries, however, the moisture evaporation will eventually not be adequate to keep the surface cooled to the wet-bulb temperature, and thus the surface temperature will break above the wet-bulb temperature. So, the relationship of the surface temperature to the wet-bulb temperature is a strong indicator of surface dryness of the product. If the product surface is completely coated with a thin layer of moisture, the moisture evaporation will cool the surface temperature down to the wet-bulb temperature, keeping it at or below the wet-bulb temperature. As the meat surface dries out, however, the surface temperature will gradually increase above the wet-bulb temperature.

In FIG. 2, this transition from wet-surface to dry-surface conditions can be seen on the plot of the surface and wet-bulb temperatures. Up until Hour 2.5, the surface was wet enough so that the surface temperature stayed below the wet-bulb temperature. At Hour 2.5, however, the surface had dried enough to transition from a wet-surface to a partially dry surface, and thus lessoning the evaporative cooling enough so that the surface temperature broke above the wet-bulb temperature. At this point, drying of the surface will result in several changes to the product. The drying of the surface will toughen surface texture, and the product will begin to experience significant yield loss. The surface dehydration will also potentially result in the desiccation of any bacteria, notably food-poisoning pathogenic bacteria, that are on the product surfaces. Many pathogenic bacteria are known to have an increased heat tolerance in the desiccated state, and thus may survive a cooking process that would otherwise be lethal to the same bacteria in the hydrated state. For smoked products that require hot, dry conditions for smoke color development, this transition point will be where the product surface rapidly develops smoke color. In industrial ovens, the drying rates of multiple different products will vary depending on the location in a fully loaded smokehouse, and as such, surface temperatures and surface dryness are often highly variable for products located in either the fast- and slow-drying locations in the oven. Multiple surface temperature probes could be used to monitor and control the process conditions based on location in the fast- or slow-drying zone in an oven.

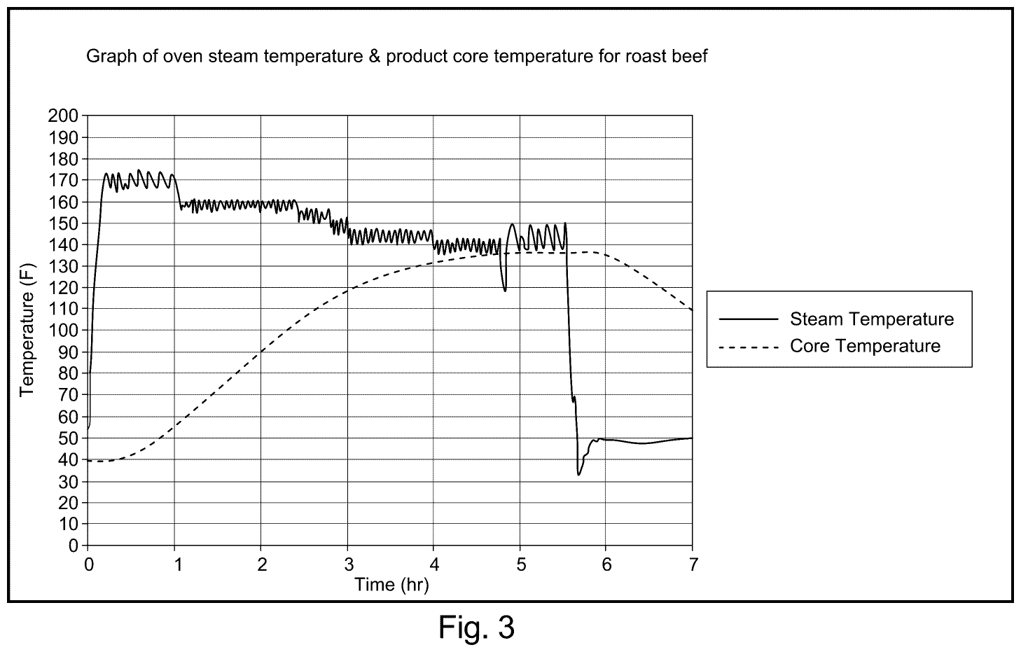

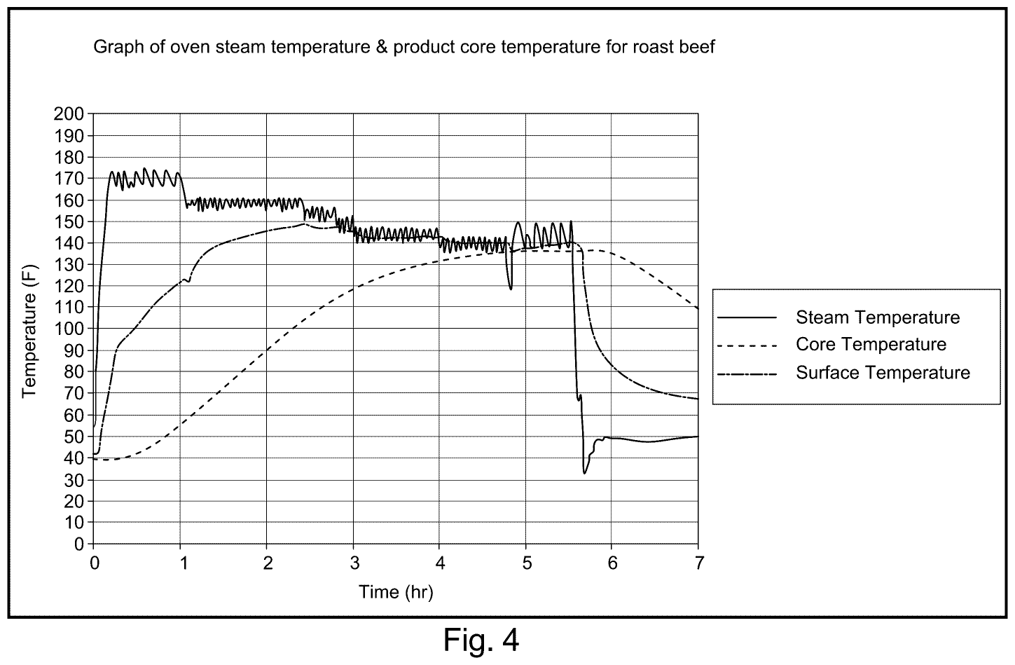

Steam or hot-water cooking processes are also commonly used in the food industry. No evaporation occurs during these processes, but measurement of surface temperatures can still be useful for process analysis and control. A steam cooking process is diagrammed in FIG. 3. This graph shows only the steam and core temperatures, and is again typical of what is commonly used in the food industry to verify that the core temperature is achieved. The shortcoming of this graph is that once again, by measuring only the core temperature and no surface temperature, the data is only useful for establishing food safety at the core but cannot be used to optimize the process for quality and yields. In FIG. 4, the product surface temperature is added to a graph of the same process. This surface temperature data could be used by a control system to control the denaturation rate of the surface proteins. Academic studies have shown that muscle proteins denature strongly in the range of 132-140° F. In the inventive control system, the controller could be programmed to monitor the surface temperature until it reaches 130° F., then automatically reduce the steam temperature from 160° F. to 145° F. so that the surface proteins were slowly denatured at 140° F., after which the controller would increase the steam temperature to finish cooking the product. An automatically surface temperature controlled process could be used to denature the surface proteins more slowly than the conventional process shown in FIG. 4, resulting in higher yields for the processor and juicier product for the consumer.

### 2. How the System Works

In an example of the inventive surface-temperature control system, one or several surface temperature probes are inserted into the meat product. The sensing tip of the probe is positioned at the surface or just under the surface of the product. The control system is programmed to control the temperatures and the step changes in the program based on the surface temperature of the product or the relationship between the surface and wet-bulb temperatures. Examples of a conventional and new steam cooking program using the invention are shown in Tables 1 and 2.

TABLE 1
Conventional Prior Art Cooking Process

| | | | |
|---|---|---|---|
| Step | Time | Steam Temp. | Action |

| 1 | 1.0 | Hr | 170 F. | |
|---|---|---|---|---|
| 2 | 1 Hr 15 Mn | | 160 F. | |
| 3 | 30 | Min | 155 F. | |
| 4 | 15 | Min | 150 F. | |
| 5 | 1.0 | Hr | 145 F. | |
| 6 | 45 | Min | 140 F. | Cook to 135 F. Core |
| 7. | 45 | Min | 140 | Hold at 135 F. for 45 |

TABLE 2
Cooking Process Example 1 (With Surface
Temperature Measurement And Control)

| Step | Time | | Steam Temp. | Action |
|---|---|---|---|---|
| 1 | 1.0 | Hr | 170 F. | |
| 2 | To 130 F. surface | | 160 F. | At 130 F. Surface, go to Step 3 |
| 3 | To 140 F. surface | | 145 F. | At 140 F. Surface, go to Step 4 |
| 4 | 15 | Min | 150 F. | |
| 5 | 1.0 | Hr | 145 F. | |
| 6 | 45 | Min | 140 F. | Cook to 135 F. core |
| 7 | 45 | Min | 140 F. | Hold at 135 F. for 45 Min |

The program listed in Table 1 is a typical cooking program used for steam cooking roast beef that is encased in a plastic film. The program in Table 1 was used to cook the roast beef shown in FIGS. 3 and 4. The program listed in Table 2, in contrast, is a new program that shows how the inventive control system would be used to cook the same product. The new program would control the process based on the product surface temperatures, thus ensuring that the surface proteins were denatured more slowly than the conventional program, resulting in increased yields and juiciness of the product cooked using the inventive controller.

The cooking programs listed in Tables 3 and 4 are examples of how the new invention would be used to precisely control the product surface conditions to optimize both smoke color and surface-protein denaturation.

TABLE 3
Another Conventional Cooking Process in the Prior Art

| Step | Time | | Dry Bulb | Wet Bulb | Smoke | Air/Exhaust | Action |
|---|---|---|---|---|---|---|---|
| 1 | 1.5 | Hr | 160 F. | 100 F. | Off | Open | |
| 2 | 1.0 | Hr | 165 F. | 118 F. | On | Closed | |
| 3 | 1.0 | Hr. | 170 F. | 115 F. | On | Closed | |
| 4 | 30 | Min | 165 F. | 150 F. | Off | Closed | |
| 5 | 2.0 | Hr | 180 F. | 180 F. | Off | Closed | Cook to 156 F. |

TABLE 4
Cooking Process Example 2 (With Surface Temperature Measurement and Control)

| Step | Time | Dry | Wet | Smoke | Air/Ex | Action |
|---|---|---|---|---|---|---|
| 1 | 1.5 Hr | 160 F. | 100 F. | Off | Open | When Surf > 105 F., go to Step 2 |
| 2 | 1.0 | 165 F. | 118 F. | On | Closed | |
| 3 | 1.0 | 170 F. | 115 F. | On | Closed | |
| 4 | 0.5 | 170 F. | 115 F. | Off | Open | When Surf > 125 F., go to Step 5 |
| 5 | 1.0 | 165 F. | 145 F. | Off | Closed | When Surf > 140 F., go to Step 6 |
| 6 | 1.0 | 175 F. | 145 F. | Off | Open | Hold to Surf > 145 F. |
| 7 | 2.0 | 180 F. | 180 F. | Off | Closed | Steam Cook to 156 F. core |

The program in Table 3 is a conventional process that was used to cook the product in FIG. 2. Smoked meats must be pre-dried before smoking to reduce the surface moisture available for smoke absorption on the product surface. Too much surface moisture would allow too much smoke penetration, resulting in an unacceptable muddy-brown color. Too little surface moisture will mean inadequate smoke absorption, resulting in an unacceptable light smoke color.

The relationship of the surface temperature to the wet-bulb temperature is a strong indicator of surface dryness. For the product in FIG. 3, field trials showed that this product absorbed the optimum amount of smoke when the surface temperature climbed to 5° F. above the wet-bulb temperature. At this surface moisture level, conditions were optimum for the right amount of smoke absorption to achieve the desired deep-red smoked color. Starting the smoke sooner in the process resulted in excess smoke absorption and a muddy-brown smoke color, while starting the smoke later in the process resulted in inadequate smoke absorption and a light-red smoke color. In conventional processes, ovens do not have surface temperature probes, so oven operators have to manually check the product surface conditions by opening the doors and physically feeling the product surface—a crude and inherently imprecise process. Using the inventive process shown in Table 4, however, the inventive controller with surface temperature probes will ensure that the product will be pre-dried in Step 1 until the surface achieves the optimum moisture conditions at 105° F. when the surface temperature is precisely 50F above the wet-bulb temperature of 100° F. Then, the program will automatically advance into the smoking step at these optimum conditions every time, with no manual guesswork needed-resulting in very consistent results from load-to-load.

Continuing in this inventive process, the product is smoked in Steps 2 and 3. After the smoking steps are completed, the program advances into Step 4, which is a post-smoke drying step that is used to dry the surface to develop the smoke color—a well-known color reaction known as Maillard browning. This Maillard browning process requires hot-dry conditions, so the inventive control system ensures that the surface is fully dry before Step 4 is completed. To accomplish this, in Step 4, the target surface temperature is set at 125° F., while the wet-bulb temperature is set at 115° F. This means that the surface will have to break above the wet-bulb temperature by 10° F. before the step advances, thus ensuring that the surface is dry enough to fully develop the smoke color before advancing into Step 5. In Step 5, the wet-bulb temperature is set at 145° F., so that the inventive controller and process are programmed to ensure that the surface proteins are slowly denatured. It is well-known that meat proteins are denatured at 140° F. In Step 5, therefore, the wet-bulb temperature is set at 145° F., and the target surface temperature is set at 140° F. This way, the controller will ensure that the surface slowly increases up to and through 140° F. and then be held there for one hour in Step 6 to make sure that the surface proteins are slowly and fully denatured before advancing the program into the more aggressive 180° F. steam-cook finishing step in Step 7. Using this approach, the inventive controller and process uses surface temperature control to reduce product defects such as fat separation, and color variation while slowly denaturing the surface proteins to create a firmer texture, higher cooking yields, higher slicing yields, and juicier products.

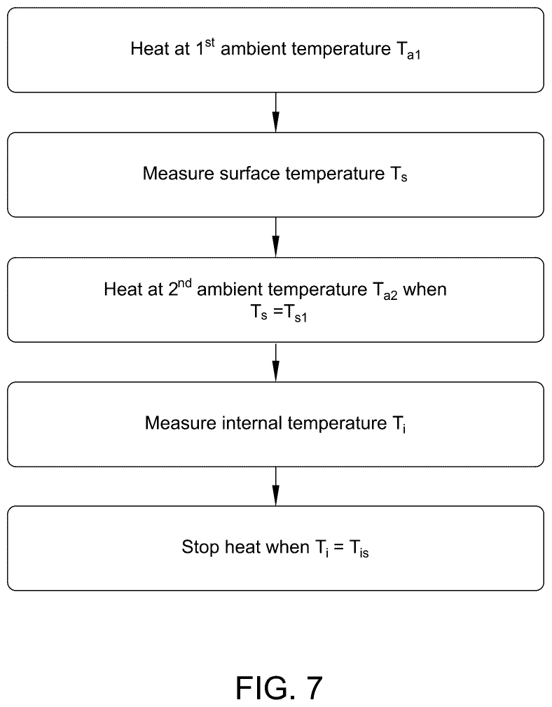

FIG. 7 is a flow diagram illustrating a basic embodiment of the process of the invention. The basic method of processing meat or meat products, comprising steps of (1) heating meat at a first ambient (or oven) temperature (Ta1); (2) measuring a surface temperature (Ts) of the meat; (3) changing the first ambient temperature to a second ambient temperature (Ta2) when the surface temperature reaches a predetermined target surface temperature (Ts1); (4) measuring an internal (core) temperature (Ti) of the meat; and (5) stopping or ceasing heating the meat when the internal temperature of the meat is equal to a predetermined safe internal temperature (Tis).

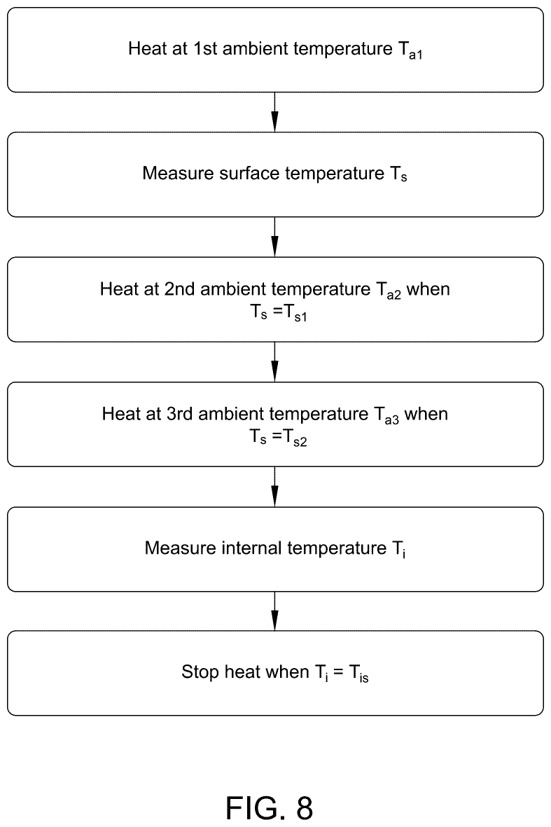

FIG. 8 shows another embodiment of method of processing meat or meat products that ensures not only safety, but improved color, texture, consistency, mouthfeel, flavor, aroma, and the like. It comprises the steps of; Step 1) heating a meat article at a first ambient temperature (Ta1);

Step 2) measuring a surface temperature (Ts) of the meat article;

Step 3) changing the first ambient temperature to a second ambient temperature (Ta2) when the surface temperature of the meat article reaches a first predetermined target surface temperature (Ts1);

Step 4) changing the second ambient temperature to a third ambient temperature (Ta3) when the surface temperature of the meat article reaches a second predetermined surface temperature (Ts2)

Step 5) measuring an internal temperature (Ti) of the meat article; and

Step 6) stop heating the meat article when the internal temperature of the meat article is equal to a predetermined safe internal temperature (Tis).

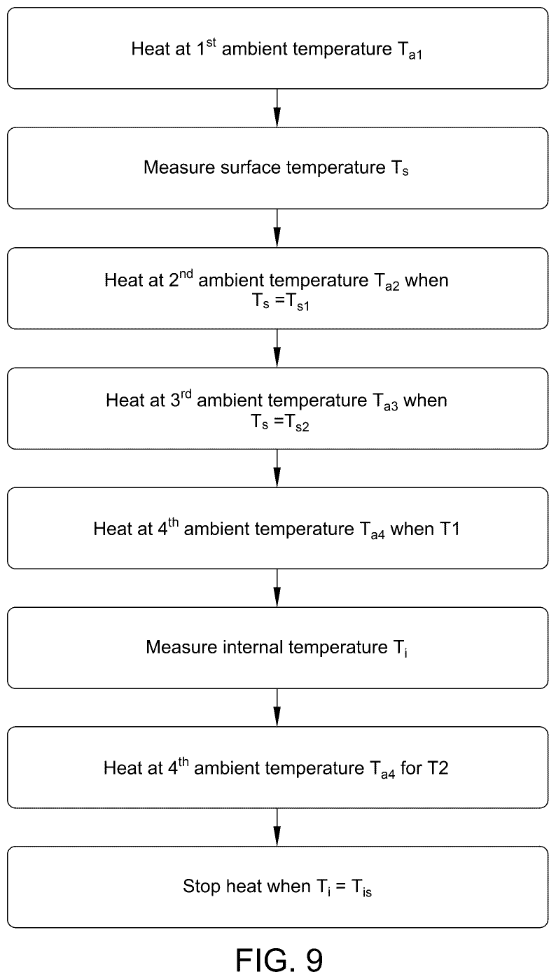

In a yet more detailed aspect, referring to FIG. 9, the method of processing meat that ensures not only safety, but optimum palatability including improved color, texture, consistency, mouthfeel, flavor, aroma, and the like, comprising steps of;
a) heating at least one meat article at a first ambient temperature (Ta1);
b) measuring a surface temperature (Ts) of the at least one meat article;
c) changing the first ambient temperature to a second ambient temperature (Ta2) when the surface temperature of the at least one meat article is equal a first predetermined target surface temperature (Ts1);
d) changing the second ambient temperature to a third ambient temperature (Ta3) when the surface temperature of the at least one meat article is equal to a second predetermined target surface temperature (Ts2);
e) changing the third ambient temperature to a fourth ambient temperature (Ta4) at a predetermined first period of time (T1);
f) measuring an internal temperature (Ti) of the at least one meat article;
g) continuing to heat the at least one meat article at the fourth ambient temperature when the internal temperature is equal to a predetermined safe internal temperature (Tis) for a predetermined second period of time (T2); and
h) stop heating the at least one meat article after the second predetermined period of time.

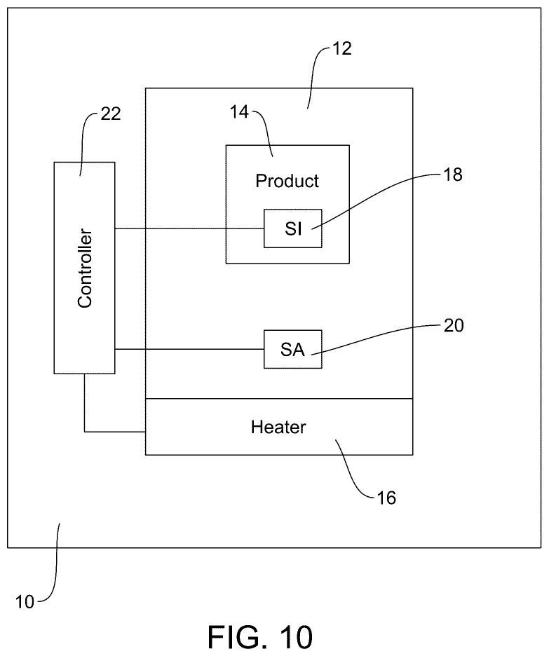

FIG. 10 is a diagram illustrating an embodiment of the apparatus of the invention. The system 10 comprises a heating chamber 12 containing product 14 to be cooked or dried, a heater 16, an internal or core temperature sensor 18, and an ambient air temperature sensor 20. The heater 16 and sensors 18 and 20 are electronically communicatively connected to a controller 22.

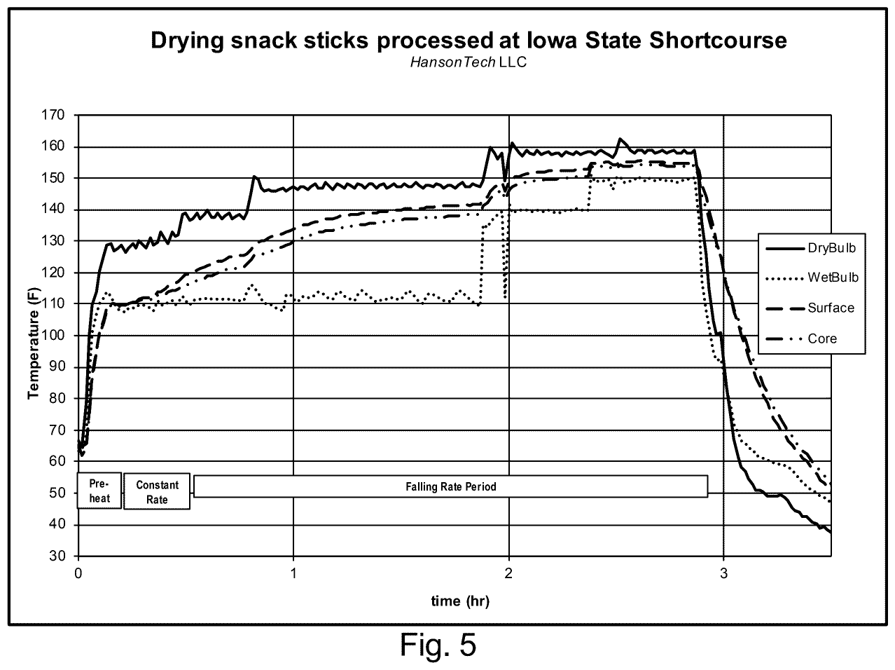

The controller and process of the invention can also be used to prevent product defects due to over-drying or rapid drying. For example, when semi-dry sausages such as snack sticks and summer sausage, or dry sausages such a pepperoni and sausage are made, a common defect know as “case-hardening” occurs when the product is dried too fast. If the product surface dries too fast, a dehydrated crust forms on the outside circumference of the sausage sticks, creating a condition know as case-hardening. An example graph that diagrams the data from a process where case-hardening occurred is shown in FIG. 5. The dehydrated rind around the outside circumference of the cylindrical sausage sticks impedes the moisture migration from the interior to the surface, thus slowing or even stopping the drying rate of the sausages. Case-hardening is a significant source of defects for sausage manufactures, leading to sub-standard quality and increased waste.

The process and controller can be used to prevent this case-hardening defect. It was discovered that when the surface temperature breaks above the wet-bulb temperature, this inflection point indicates that case-hardening is initiated (FIG. 5). As long as the surface is moist, it will not case-harden, and moisture will continue to migrate to the surface at a constant rate. By tracking the surface temperature, the control system can detect when the surface temperature breaks above the wet-bulb temperature, and either alert the operator to make adjustments to the process, or automatically adjust the process to avoid case-hardening.

In the meat industry, dry sausages such as pepperoni and salami are slowly dried in large drying rooms. These drying processes are very slow, often requiring 9-14 days for cylindrical pepperoni sticks or more than 30 days for larger diameter salami sticks. The total drying time that is needed to dry the sausages down to the required moisture and water activity levels depends on the diameter of the sausage cylinders, the type of casing that is used, and the ingredients, meats, and fat level of the sausage formula. During this lengthy drying process, the drying rate must be optimally controlled—not too fast and not too slow—so that the moisture migrates from the interior to the surface at the same rate as it evaporates from the surface to the air. If the product is dried too fast, the surface will case-harden and trap the moisture in the interior of the sausage, which stops the drying process and results in unusable product. This case-hardening defect is one of the leading causes of waste in the industry. In contrast, if the product is dried too slowly, the overall manufacturing time for the product will be lengthened, thus reducing productivity. Also, if the surface stays too moist for too long, unsightly mold growth may occur. For some sausages, though. mold growth is intentional, and so precise control of drying rates is helpful in either promoting or preventing mold growth, whichever is desirable.

In conventional drying rooms, the operators manually track the drying process by weighing and measuring the circumference of product samples daily to try to track the drying progress. This manual tracking of the drying process is crude and imprecise, leading to significant process failures, waste, inaccurate scheduling, and lost productivity. In contrast, the inventive process and controller can automatically and precisely track and control the surface and wet-bulb temperatures during drying to precisely control the drying rate to maintain optimal drying conditions and to prevent or promote mold growth as desired. For example, using the inventive controller, if the surface temperature creeps above the wet-bulb temperature, the control system can be programmed to recognize this undesired inflection point, and either activate an alarm for manual intervention or automatically adjust the process to prevent the onset of case-hardening. An example of a conventional drying process and an inventive drying process are shown in Tables 5 and 6.

TABLE 5
Conventional Drying Process for Pepperoni

| | | | | Relative | |
|---|---|---|---|---|---|
| Step | Time | Dry Bulb | WetBulb | Humidity | Action |
| 1 | 5-6 days | 61 F. | 55 F. | 69% | |
| 2 | 4-5 days | 62 F. | 57 F. | 74% | Dry to 0.85 water activity |

TABLE 6
Drying Process Example 3 (with Surface Temperature Measurement and Control)

| | | | | Relative | |
|---|---|---|---|---|---|
| Step | Time | DryBulb | WetBulb | Humidity | Action |
| 1 | 5 days | 61 F. | 55 F. | 69% | If surf > 55 F., advance to Step 2 |
| 2 | 4 days | 62 F. | 57 F. | 74% | If surf > 57 F., activate alarm |
| | | | | | Dry to 0.85 water activity |

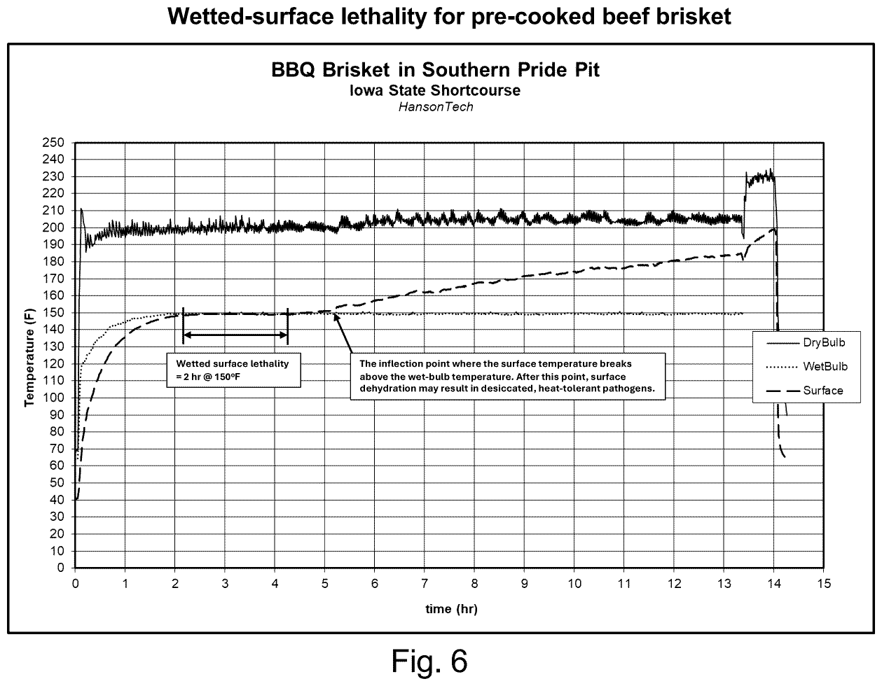

Another use for the inventive process and controller is to ensure the destruction of pathogenic bacteria on product surfaces of pre-cooked meat products during cooking. It is well known that if meat surfaces are dried during cooking (a necessary part of many cooking processes), pathogenic bacteria that are present on the surfaces may become desiccated. The heat tolerance for desiccated pathogens is much higher than for non-desiccated pathogens. As such, desiccated pathogens can withstand cooking temperatures that would be otherwise lethal for the same pathogen if hydrated. Thus, the surface dehydration of meat products during cooking may significantly increase the population of desiccated, heat-tolerant pathogens that can survive the cooking process. The inventive controller can be used to reduce this risk of desiccation by ensuring that the surface is hydrated when a lethal temperature is achieved for a sufficient time to achieve a targeted level of pathogen destruction. The inventive controller can be used to track the surface and wet-bulb temperatures during cooking to ensure that the surfaces are exposed to a lethal time-temperature treatment while still hydrated—i.e., before the surface temperature breaks above the wet-bulb temperature. If the surface temperature breaks above the wet-bulb temperature before a lethal time-temperature is achieved, this indicates that the surface is dehydrated before the target lethality is achieved, and thus the risk of an increased population of desiccated, heat-tolerant pathogens is higher. An example of a cooking process for beef barbecue that is designed to ensure sufficient surface lethality under wetted-surface conditions at a lethal temperature is listed in Table 7 and data for an example process shown in FIG. 6.

TABLE 7
Process for Ensuring Surface Lethality Example 4

| Step | Time | DryBulb | WetBulb | Smoke | Air/Exhaust | Action |
|---|---|---|---|---|---|---|
| 1 | 2.0 Hr | 200 F. | 150 F. | On | Closed | |
| 2 | 2.0 Hr | 200 F. | 150 F. | On | Closed | If Surf > 150 F., then alarm |
| 3 | 8.0 Hr. | 205 F. | 150 F. | On | Closed | |
| 4 | 1.0 Hr | 230 F. | 150 F. | Off | Open | Cook to 185 F. |

Although the apparatus and methods of the invention have been described in connection with ham, roast beef, dry sausage, and barbecued beef, it can readily be appreciated that it is not limited solely to such meats, and can be used in other meats including, but not limited to other pork and beef, chicken, turkey and other fowl, lamb, sausages, and the like.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the invention or elements thereof may by described in terms of vertical, horizontal, transverse (lateral), longitudinal, and the like, it should be understood that variations from the absolute vertical, horizontal, transverse, and longitudinal are also deemed to be within the scope of the invention.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

1. A method of processing meat or meat products, comprising steps of:
heating meat at a first ambient temperature Ta1;
measuring a surface temperature Ts of the meat;
changing the first ambient temperature to a second ambient temperature Ta2 when the surface temperature of the meat reaches a predetermined target surface temperature Ts1;
measuring an internal temperature Ti of the meat; and
reducing the ambient temperature when the internal temperature of the meat is equal to a predetermined safe internal temperature Tis.

2. The method of claim 1, further comprising a step of changing the second ambient temperature to a third ambient temperature Ta3 when the surface temperature of the meat reaches a second predetermined surface temperature Ts2.

3. The method of claim 2, wherein the step of changing the second ambient temperature to the third ambient temperature when a measured surface temperature of the meat reaches the predetermined surface temperature, is repeated.

4. The method of claim 1, further comprising a step of changing the second ambient temperature to a third ambient temperature after a first predetermined period of time Tx1.

5. The method of claim 4, further comprising a step of maintaining the first, second, or third ambient temperature for a second predetermined period of time Tx2.

6. The method of claim 1, wherein the change in ambient temperature comprises increasing the ambient temperature.

7. The method of claim 1, wherein a change in ambient temperature comprises decreasing the ambient temperature.

8. The method of claim 1, wherein the first ambient temperature is between 100 and 180 F.

9. The method of claim 5, wherein the second predetermined period of time Tx2 is between 15 minutes and 2 hours.

10. The method of claim 1, further comprising at least one step of adding smoke to the meat.

11. The method of claim 1, further comprising at least one step of exhausting heat from the meat.

12. The method of claim 1, further comprising at least one step of forcing air convection to the meat.

13. The method of claim 1, further comprising at least one step of adding moisture or liquids to the meat.

14. The method of claim 1, wherein the first and second ambient temperatures are measured as dry-bulb temperatures.

15. The method of claim 14, further comprising, before the changing step, measuring an ambient wet-bulb temperature.

16. The method of claim 15, wherein the target surface temperature Ts1 is the temperature at which the surface temperature of the meat is equal to the ambient wet-bulb temperature.

17. The method of claim 1, wherein the step of heating is implemented in system comprising at least one product chamber, at least one heating element, at least one ambient temperature sensor, at least one surface temperature sensor, at least one internal temperature sensor, and a controller communicatively connected to the other system elements.

18. The method of claim 1, wherein the meat or meat products is selected from the group consisting of pork, beef, poultry, sausage, cured meat, smoked meat, and dried meat.

19. A method of heating or drying meat or meat products for safety and desirability, comprising steps of;
a) heating a meat article at a first ambient dry-bulb temperature Ta1;
b) measuring a surface temperature Ts of the meat article and an ambient wet-bulb temperature;
c) changing the first ambient dry-bulb temperature to a second ambient dry-bulb temperature Ta2 when the surface temperature of the meat article reaches a first target surface temperature Ts1, wherein the first target surface temperature is determined when the surface temperature is equal to the ambient wet-bulb temperature;
d) changing the second ambient dry-bulb temperature to a third ambient dry-bulb temperature Ta3 when the surface temperature of the meat article reaches a second target surface temperature Ts2;
e) measuring an internal temperature Ti of the meat article; and
f) reducing the third ambient temperature when the internal temperature of the meat article is equal to a predetermined safe internal temperature Tis.

20. A method of heating, cooking or drying meat or meat based products for sanitation and for optimized color, texture, consistency, and mouthfeel, comprising steps of;
a) heating at least one meat article at a first ambient dry-bulb temperature (Ta1);
b) measuring a surface temperature (Ts) of the at least one meat article and an ambient wet-bulb temperature;
c) changing the first ambient dry-bulb temperature to a second ambient dry-bulb temperature (Ta2) when the surface temperature of the at least one meat article is equal a first target surface temperature (Ts1);
d) changing the second ambient dry-bulb temperature to a third ambient dry-bulb temperature (Ta3) when the surface temperature of the at least one meat article is equal to a second target surface temperature (Ts2), wherein the second target surface temperature is determined when the surface temperature is equal to the ambient wet-bulb temperature;
e) changing the third ambient dry-bulb temperature to a fourth ambient dry-bulb temperature (Ta4) after a first period of time (T1);
f) measuring an internal temperature (Ti) of the at least one meat article;
g) maintaining the fourth ambient temperature when the internal temperature is equal to a predetermined safe internal temperature (Tis) for a second period of time (T2); and
h) reducing the fourth ambient temperature after the second period of time.
